(19) United States
(12) Patent Application Publication
(10) Pub. No.: US 2025/0371927 A1
(43) Pub. Date: Dec. 4, 2025

(54) KIOSK ASSEMBLY

(71) Applicant: GoRaqt, Inc., Lake George, NY (US)

(72) Inventors: John Paul Missale, Brooklyn, NY (US); Nancy Ann Hawley, Lake George, NY (US); Michael Doria Agbuya, Virginia Beach, VA (US); Yingying Lu, New York, NY (US); Jonathan Harold Levey, Pound Ridge, NY (US); Kim Marie Missale, Lake George, NY (US)

(21) Appl. No.: 19/226,508

(22) Filed: Jun. 3, 2025

Related U.S. Application Data
(60) Provisional application No. 63/655,341, filed on Jun. 3, 2024.

(51) Int. Cl. G07F 17/00; G07F 9/02; G07F 11/16; G07F 11/72; G07F 17/32

(52) U.S. Cl. CPC G07F 17/0042; G07F 9/0235; G07F 9/026; G07F 11/165; G07F 11/72; G07F 17/3225

(57) ABSTRACT

A kiosk assembly for allowing a user to demo, rent, or purchase sports goods. The kiosk comprising a kiosk structure, and an automated kiosk management system comprising a user interaction sub-system for managing interactions with a user, a sports goods delivery and return sub-system that manages automated delivery of sports goods to the user and return of sports goods from the user, a hygiene management sub-system that manages cleaning and disinfection of the sports goods, and a quality management sub-system that manages maintenance and recycling of the sports goods.

### CROSS REFERENCE TO RELATED APPLICATIONS

This application claims the benefit of U.S. Provisional Application No. 63/655,341, filed Jun. 3, 2024, which is incorporated by reference in its entirety.

### TECHNICAL FIELD OF INVENTION

The present invention generally relates to a kiosk assembly. More particularly, the present invention relates to a kiosk assembly for allowing a user to demo, rent, or purchase sports goods.

### BACKGROUND OF THE INVENTION

Playing sports offers a wide array of benefits that extend beyond physical health. Sports offer physical benefits such as improved cardiovascular health and enhanced endurance, but they also have mental and emotional benefits such as reduced stress and improved mood, social benefits such as fostering teamwork and building friendships, and personal development benefits such as goal setting and leadership skills. Many people would be willing to learn to play a new sport, but there is currently no easily-accessible method to do so. Barriers to entry for any sport are high, in the form of both time, knowledge, and money. In the current market, a new player must research the equipment used for the sport they would like to learn to play and try to understand which features are most relevant. This in itself requires time and mental load that may deter a player. If the player does decide on which equipment to buy, they must purchase the equipment and hope the right choice was made. Many people do not have the resources to purchase sporting equipment, as it can be very costly and requires a large amount of money upfront. They also do not have knowledge of equipment that is critical to the sport in helping them play their best.

Therefore, there is a continued need in the art for a solution that solves the three-prong problem of time, knowledge, and money to allow a person to quickly and easily access sporting equipment relevant to the player at a low cost.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

Aspects of the present invention relate to a kiosk assembly for allowing a user to demo, rent, or purchase sports goods. The kiosk comprises a kiosk structure, and an automated kiosk management system comprising a user interaction sub-system for managing interactions with a user, a sports goods delivery and return sub-system that manages automated delivery of sports goods to the user and return of sports goods from the user, a hygiene management sub-system that manages cleaning and disinfection of the sports goods, and a quality management sub-system that manages maintenance and recycling of the sports goods.

According to some aspects, the kiosk structure comprises a protective enclosure, at least one first storage compartment to store at least one sports good, a loading dock for delivery of a sports good to the user or for receiving a sports good from the user, and a conveyance assembly that conveys a sports good from the first compartment to the loading dock or conveys a sports good from the loading dock to the first storage compartment.

According to some aspects, the kiosk structure comprises an actuable door that is actuatable between a closed position and an open position, wherein the actuable door allows access of the loading dock to the user in the open position, and wherein the actuable door restricts access of the loading dock to the user in the closed position.

According to some aspects, the kiosk structure comprises the kiosk structure comprises an actuable lock that locks or unlocks the actuable door.

According to some aspects, the kiosk structure comprises a safety panel actuatable between a closed position and an open position, wherein the safety panel in the closed position disallows movement of any matter between the loading dock and the conveyance system, and wherein safety panel in the open position allows passage of sports goods between the loading dock and the conveyance system.

According to some aspects, the user interaction sub-system comprises a touch screen display to allow a user to engage with the kiosk assembly, a first communication circuit that communicates with other sub-systems of the kiosk assembly and devices external to the kiosk assembly via a wired or wireless mode of communication, and a first control circuit configured to operate the touch screen display and the communication circuit.

According to some aspects, the sports goods delivery and return sub-system comprises one or more actuators configured to operate the conveyance system, the actuable door, actuable lock, and the safety panel.

According to some aspects, the sports goods delivery and return sub-system comprises a second communication circuit that communicates with the user interaction sub-system or devices external to the kiosk assembly via a wired or wireless mode of communication, and a second control circuit configured to operate the one or more actuators and the second communication circuit.

According to some aspects, the hygiene management sub-system comprises at least one UV disinfecting light positioned in the storage compartment.

According to some aspects, the hygiene management sub-system comprises at least one of a chemical disinfectant spray assembly, heat disinfection assembly, laser cleaning system, a steam sterilization system, and a washing system.

According to some aspects, the hygiene management sub-system comprises a third communication circuit that communicates with the user interaction sub-system or devices external to the kiosk assembly via a wired or wireless mode of communication, and a third control circuit configured to operate the hygiene management sub-system.

According to some aspects, the quality management sub-system comprises a vision system to identify sports goods needing maintenance or recycling, and one or more second storage compartments for storing sports goods identified as needing maintenance or repair.

According to some aspects, the vision system comprises at least one of a camera, a LIDAR system, an ultraviolet imaging system, an infrared imaging system, a thermal imaging system, and an acoustic imaging system.

According to some aspects, the vision system comprises a neural network circuit trained to identify sports goods needing maintenance or recycling.

According to some aspects, the quality management sub-system comprises a fourth communication circuit that communicates with the user interaction sub-system or devices external to the kiosk assembly via a wired or wireless mode of communication, and a fourth control circuit configured to operate the quality management sub-system.

According to some aspects, automated kiosk management system comprises a security sub-system.

According to some aspects, the security sub-system comprises one or more cameras positioned outside the kiosk structure to monitor user interaction with the kiosk assembly, and one or more cameras positioned inside the kiosk structure to monitor sports goods in the first storage compartment, the conveyance system, and the loading dock.

According to some aspects, the security sub-system comprises a fifth communication circuit that communicates with the user interaction sub-system or devices external to the kiosk assembly via a wired or wireless mode of communication, and a fifth control circuit configured to operate the security sub-system.

According to some aspects, the security sub-system comprises one or more of an alarm and at least one flashing light.

According to some aspects, the automated kiosk management system comprises a sports goods tracking sub-system.

According to some aspects, the sports goods tracking sub-system comprises a QR Code scanner that scans QR codes printed on the sports goods.

According to some aspects, the sports goods tracking sub-system comprises an RFID reader that reads RFID Tag signatures of RFID Tags embedded in sports goods.

According to some aspects, the sports goods tracking sub-system comprises a sixth communication circuit that communicates with the user interaction sub-system or devices external to the kiosk assembly via a wired or wireless mode of communication; and a sixth control circuit configured to operate the sports goods tracking sub-system.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF ACCOMPANYING DRAWINGS

Some of the objects of the invention have been set forth above. These and other objects, features, aspects and advantages of the present invention will become better understood with regard to the following description, appended claims and accompanying drawings where:

FIGS. 1A-1D are schematic representations of the kiosk assembly of the present invention, where FIG. 1A depicts an external view of the kiosk assembly, FIGS. 1B-1C depict an internal view of the kiosk assembly; and FIG. 1D depicts a block diagram of an automated kiosk management system of the kiosk assembly.

Corresponding reference numerals indicate corresponding parts throughout the drawings.

### DETAILED DESCRIPTION OF INVENTION

The following detailed description should be read with reference to the drawings in which similar elements in different drawings are numbered the same. The drawings, which are not necessarily to scale, depict illustrative embodiments and are not intended to limit the scope of the invention. Although examples of construction, dimensions, and materials are illustrated for the various elements, those skilled in the art will recognize that many of the examples provided have suitable alternatives that may be utilized.

### Overview

Embodiments of the present invention relate to a kiosk assembly for allowing a user to demo, rent, or purchase sports goods.

Embodiments of the present invention disclose a kiosk assembly that comprises a kiosk structure, and an automated kiosk management system comprising a user interaction sub-system for managing interactions with a user, a sports goods delivery and return sub-system that manages automated delivery of sports goods to the user and return of sports goods from the user, a hygiene management sub-system that manages cleaning and disinfection of the sports goods, and a quality management sub-system that manages maintenance and recycling of the sports goods.

In some embodiments, the kiosk structure comprises a protective enclosure, at least one first storage compartment to store at least one sports good, a loading dock for delivery of a sports good to the user or for receiving a sports good from the user, and a conveyance assembly that conveys a sports good from the first compartment to the loading dock or conveys a sports good from the loading dock to the first storage compartment. In some embodiments, the kiosk structure comprises an actuable door that is actuatable between a closed position and an open position, wherein the actuable door allows access of the loading dock to the user in the open position, and wherein the actuable door restricts access of the loading dock to the user in the closed position. In some embodiments, the kiosk structure comprises the kiosk structure comprises an actuable lock that locks or unlocks the actuable door. In some embodiments, the kiosk structure comprises a safety panel actuatable between a closed position and an open position, wherein the safety panel in the closed position disallows movement of any matter between the loading dock and the conveyance system, and wherein safety panel in the open position allows passage of sports goods between the loading dock and the conveyance system.

In some embodiments, the user interaction sub-system comprises a touch screen display to allow a user to engage with the kiosk assembly, a first communication circuit that communicates with other sub-systems of the kiosk assembly and devices external to the kiosk assembly via a wired or wireless mode of communication, and a first control circuit configured to operate the touch screen display and the communication circuit.

In some embodiments, the sports goods delivery and return sub-system comprises one or more actuators configured to operate the conveyance system, the actuable door, actuable lock, and the safety panel. In some embodiments, the sports goods delivery and return sub-system comprises a second communication circuit that communicates with the user interaction sub-system or devices external to the kiosk assembly via a wired or wireless mode of communication, and a second control circuit configured to operate the one or more actuators and the second communication circuit.

In some embodiments, the hygiene management sub-system comprises at least one UV disinfecting light positioned in the storage compartment. In some embodiments, the hygiene management sub-system comprises at least one of a chemical disinfectant spray assembly, heat disinfection assembly, laser cleaning system, a steam sterilization system, and a washing system. In some embodiments, the hygiene management sub-system comprises a third communication circuit that communicates with the user interaction sub-system or devices external to the kiosk assembly via a wired or wireless mode of communication, and a third control circuit configured to operate the hygiene management sub-system.

In some embodiments, the quality management sub-system comprises a vision system to identify sports goods needing maintenance or recycling, and one or more second storage compartments for storing sports goods identified as needing maintenance or repair. In some embodiments, the vision system comprises at least one of a camera, a LIDAR system, an ultraviolet imaging system, an infrared imaging system, a thermal imaging system, and an acoustic imaging system. In some embodiments, the vision system comprises a neural network circuit trained to identify sports goods needing maintenance or recycling. In some embodiments, the quality management sub-system comprises a fourth communication circuit that communicates with the user interaction sub-system or devices external to the kiosk assembly via a wired or wireless mode of communication, and a fourth control circuit configured to operate the quality management sub-system.

In some embodiments, automated kiosk management system comprises a security sub-system. In some embodiments, the security sub-system comprises one or more cameras positioned outside the kiosk structure to monitor user interaction with the kiosk assembly, and one or more cameras positioned inside the kiosk structure to monitor sports goods in the first storage compartment, the conveyance system, and the loading dock. In some embodiments, the security sub-system comprises a fifth communication circuit that communicates with the user interaction sub-system or devices external to the kiosk assembly via a wired or wireless mode of communication, and a fifth control circuit configured to operate the security sub-system. In some embodiments, the security sub-system comprises one or more of an alarm and at least one flashing light.

In some embodiments, the automated kiosk management system comprises a sports goods tracking sub-system. In some embodiments, the sports goods tracking sub-system comprises a QR Code scanner that scans QR codes printed on the sports goods. In some other embodiments, the sports goods tracking sub-system comprises an RFID reader that reads RFID Tag signatures of RFID Tags embedded in sports goods.

In some embodiments, the sports goods tracking sub-system comprises a sixth communication circuit that communicates with the user interaction sub-system or devices external to the kiosk assembly via a wired or wireless mode of communication; and a sixth control circuit configured to operate the sports goods tracking sub-system.

### DESCRIPTION OF EMBODIMENTS

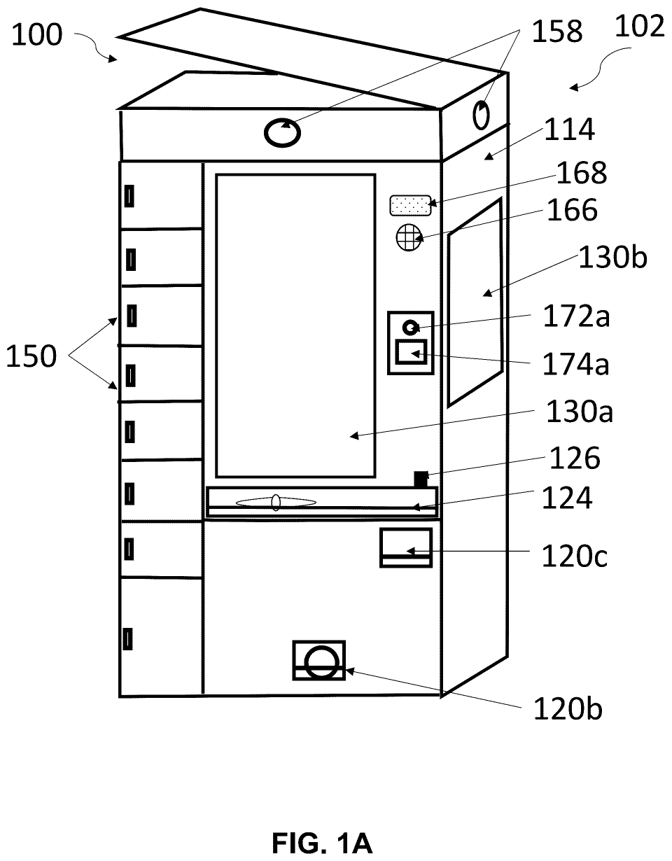

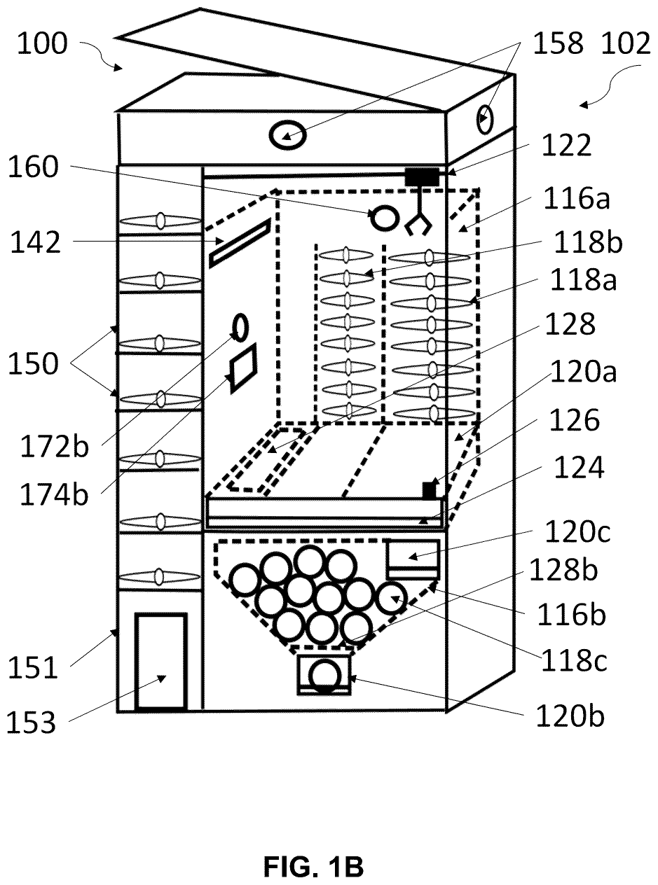

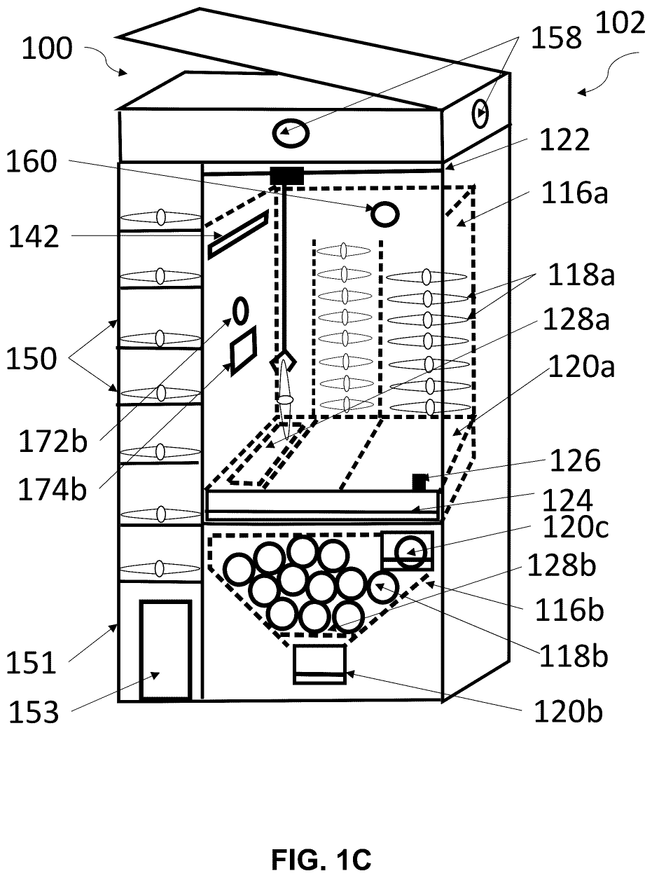

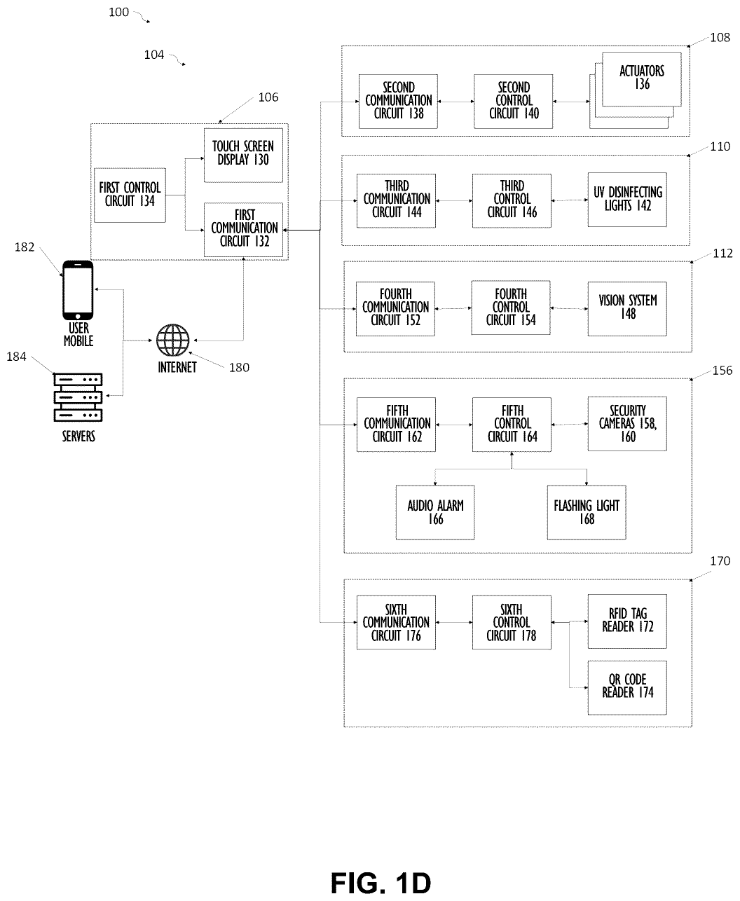

FIGS. 1A-1D are schematic representations of the kiosk assembly 100 of the present invention, where FIG. 1A depicts an external view of the kiosk assembly 100, FIGS. 1B-1C depict an internal view of the kiosk assembly 100; and FIG. 1D depicts a block diagram of an automated kiosk management system 104. The kiosk assembly 100 that comprises a kiosk structure 102.

In some embodiments, the kiosk structure 102 comprises an protective enclosure 114, at least one first storage compartment 116 to store at least one sports good 118, a loading dock 120 for delivery of a sports good 118 to the user or for receiving a sports good 118 from the user, and a conveyance assembly 122 that conveys a sports good 118 from the first storage compartment 116 to the loading dock 120 or conveys a sports good 118 from the loading dock 120 to the first storage compartment 116.

### Protective Enclosure 114

In some embodiments, the protective enclosure 114 houses all components of the kiosk structure 102. In some embodiments, the protective enclosure 114 includes a load bearing frame that bears the weight of the components of the kiosk assembly 100 including the sports goods 118 and protects the components of the kiosk assembly 100 from the outside environment and unauthorized access.

In some embodiments, the protective enclosure 114 is of a substantially cuboidal shape. However, said shape of the protective enclosure 114 is not restrictive. The protective enclosure 114 can be made of any possible shape, such as a cylinder, sphere, cubical, pyramidal, octagonal, irregular, or any other shape.

In some embodiments, the protective enclosure 114 is made of a sturdy, weather proof, and difficult to break material, such as, metals, metal alloys, hard plastics, or any composite material. In some embodiments, the protective enclosure 114 includes a frame made of load bearing members, such as but not limited to, metal or metal alloy tubes, angles, Beams, Channels, enclosed in an enclosing structure, such as a sheet metal or plastic body or structure. In some embodiments, the protective enclosure 114 is of a cuboidal shape.

In some embodiments, the protective enclosure 114 includes a frame made by welding together high strength steel rectangular tube sections, and is covered by sheets of stainless steel, aluminum, aluminum alloy, hard plastic, or composite materials, such as fiberglass.

### First Storage Compartment 116

In some embodiments, the first storage compartment 116 is a compartment within the cavity of the protective enclosure configured to house multiple different types of sports goods, such as Tennis Rackets, Pickle Ball Rackets, Badminton Rackets, Squash Rackets, Cricket Bats, Table Tennis Bats, Balls of different types, Shuttle Cocks, etc. Some other sports goods include, sports drinks, sports food bars, sports accessories, etc. In some embodiments, as shown, the first storage compartment 116 can have different sections, such as a section 116a and 116b. For example, as shown, section 116a stores tennis rackets 118a or pickleball rackets 118b as discussed above, and section 116b sports goods, such as, tennis balls 118c. Further, as shown, in some embodiments, the sections 116a can include separation walls that separate columns different sports goods, for example, separate a column of tennis rackets 118a from a column of pickleball rackets 118b. Although, not shown additional sections of the first storage compartment can house other sports goods such as pickle balls.

In some embodiments, the first storage compartment 116 is of a cuboidal shape.

### Loading Dock 120

In some embodiments, the loading dock 120 is a cuboidal structure positioned within the protective enclosure 114 and the first storage compartment 116, and has a portion accessible to the outside of the protective enclosure 114 to allow a user to receive a sports good 118 from the kiosk assembly 100 or deposit a sports good 118 to the kiosk assembly 100 without gaining direct access to the first storage compartment 116. In some embodiments, the loading dock 120 comprises a portion accessible to the first storage compartment 116, to allow conveyance of a sports good 118 to the loading dock 120 from the storage compartment 116.

In some embodiments, as shown, there can be more than one loading docks 120, for example, a loading dock 120a for receiving or depositing tennis rackets 118a or pickleball rackets 118b, a loading dock 120b for receiving tennis balls 118c, and a loading dock 120c for depositing tennis balls 118c from the first storage compartment 116. However, in other embodiments, a single loading dock 120 may be used for both receiving or delivering all types of sports goods 118.

In some embodiments, the loading docks 120a, 120b, and 120c are made of sheet metals or alloys such as, steel, aluminum, or hard plastics or composites, such as fiberglass.

In some embodiments, the loading docks 120a, 120b, and 120c are of a cuboidal shape

### Conveyance Assembly 122

In some embodiments, the conveyance assembly 122 transports sports goods 118 to and from their respective storage positions in the first storage compartment 116 to the loading dock 120.

In some embodiments, as shown in FIGS. 1B and 1C, the conveyance assembly 122 includes a robotic manipulator positioned in the section 116a that can pick-up different sports goods, for example, tennis rackets 118a or pickleball rackets 118b from their respective stacked columns in the section 116a and drop them in the loading dock 120a.

In some embodiments, as shown, the section 116b is shaped as a funnel and acts as a gravitational conveyance system itself that allows delivery of tennis balls 118c to the loading dock 120b and receipt of tennis balls 118c in the loading dock 120c.

In some other embodiments, other known conveyance systems known to persons skilled in the art can be utilized to transports sports goods 118 to and from their respective storage positions in the first storage compartment 116 to the loading dock 120.

### Actuable Door 124

In some embodiments, the kiosk structure 102 comprises an actuable door 124 that is actuatable between a closed position and an open position, wherein the actuable door 124 allows access of the loading dock 120 to the user in the open position, and wherein the actuable door 124 restricts access of the loading dock 120 to the user in the closed position. In some embodiments, the door 124 is positioned in front of the portion of the loading dock 120 accessible to the outside of the protective enclosure 114 and provides a closable access to said portion.

In some embodiments, the actuable door 124 is configured with an actuation mechanism comprising actuators (such as motors) and corresponding components, such as, gears, cables, etc. that allow motion of actuable door 124 in an open and a closed position. In some embodiments, the actuators of the actuable door 124 are configured to be controlled by the sports goods delivery and return sub-system 108, described in detail below.

In some embodiments, the actuable door 124 is of a substantially rectangular shape.

In some embodiments, the actuable door 124 is made of sheet metals or alloys such as, steel, aluminum, or hard plastics or composites, such as fiberglass.

### Actuable Lock 126

In some embodiments, the kiosk structure 102 comprises an actuable lock 126 that locks or unlocks the actuable door 124. In some embodiments, the actuable lock 126 is an electronically actuable lock that locks or unlocks the actuable door 124. In some embodiments, the actuable lock 126 can be any suitable electronically controlled lock available off-the shelf. In some other embodiments, the actuable lock 126 can be custom made using actuators (such as electric motors) and other known locking components.

In some embodiments, actuable lock 126 is electronically controlled by the sports goods delivery and return sub-system 108, described in detail below.

### Safety Panel 128

In some embodiments, the kiosk structure 102 comprises a safety panel 128 that acts as an additional level of segregation between the external environment and the inside of the first storage compartment 116.

In some embodiments, the safety panel 128 is actuatable between a closed position and an open position, where, the safety panel 128 in the closed position disallows movement of any matter between the loading dock 120 and the conveyance assembly 122, and where, the safety panel 128 in the open position allows passage of sports goods 118 between the loading dock 120 and the conveyance assembly 122.

In some embodiments, the safety panel 128 is positioned in front of the portion of the loading dock 120 accessible to the inside of the first storage compartment 116 and provides a closable access to said portion.

In some embodiments, the safety panel 128 is configured with an actuation mechanism comprising actuators (such as motors) and corresponding components, such as, gears, cables, etc. that allow motion of safety panel 128 in an open and a closed position. In some embodiments, the actuators of the safety panel 128 are configured to be controlled by the sports goods delivery and return sub-system 108, described in detail below.

In some embodiments, as shown, there are two safety panels 128a for the section 116a of the first storage compartment 116 and the safety panels 128b of the section 116b of the first storage compartment 116.

In some embodiments, the safety panel 128a and 128b are of a substantially rectangular shape.

In some embodiments, the safety panels 128a and 128b are made of sheet metals or alloys such as, steel, aluminum, or hard plastics or composites, such as fiberglass.

### Automated Kiosk Management System 104

### User Interaction Sub-System 106

In some embodiments, the kiosk assembly 100 comprises an automated kiosk management system 104 that comprises a user interaction sub-system 106 for managing interactions with a user. In some embodiments, the user interaction sub-system 102 comprises a touch screen display 130 to allow a user to engage with the kiosk assembly 102, a first communication circuit 132 that communicates with other sub-systems of the kiosk assembly 102 and devices external to the kiosk assembly 102 via a wired or wireless mode of communication, and a first control circuit 134 configured to operate the touch screen display 130 and the first communication circuit 132.

### Touch Screen Display 130

In some embodiments, as shown, the user interaction sub-system 106 includes more than one touch screen display 130a, 130b, each positioned on a side of the kiosk assembly 100. In some embodiments, one touchscreen display 130a provides a user interaction graphical user interface (GUI), while the other touch screen display 130b provides advertisements to the users. In some other embodiments, more than two touchscreen displays may be positioned on the kiosk assembly 100 at different locations and may provide different information or interactions to the user. In some embodiments, the touchscreen displays 130 may be an off-the shelf available touch screen display known to persons skilled in the art.

### First Communication Circuit 132

In some embodiments, the first communication circuit 132 comprises at least one of a wired, wireless, or optical fiber communication circuit configured to communicate with other sub-systems of the automated kiosk management system 104 and to external devices, such as a user mobile 182 or a server 184 via internet 180. In some embodiments, the first communication circuit 132 can be an electronic circuit capable of communicating via one or more wired or wireless mode of communication. For example, the first communication circuit 132 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks. In some embodiments, the communication circuit 132 is integrated with or communicatively linked to the first control circuit 134.

### First Control Circuit 134

In some embodiments, the first control circuit 134 can include any microcontroller or microcomputer that controls the touch screen displays 130a and 130b, and the first communication circuit 132. In some embodiments, the first control circuit 134 includes an Intel® NUC or similar small form factor computer offered by various manufacturers, such as Intel, AMD, or other chip manufacturers. The first control circuit 134 can give data or instructions to or receive data or instructions from other sub-systems of the automated kiosk management system 104 and to external devices, such as the user mobile 182 or the server 184 via the internet 180 and the first communication circuit 132. In some embodiments, the first control circuit 134 may include additional components, such as a memory device, such as a hard disk device, a mother board, an Input/Output Bus, a power management circuit, a back-up power battery, etc.

In some embodiments, the first control circuit 134 and the first communication circuit 132 may be integrated on a single motherboard and may be housed in a protective casing 153 positioned in a lockable compartment 151 of the kiosk assembly 100. In some embodiments, the touch screen displays 130 are connected to the first control circuit 134 via a wired connection.

### Sports Goods Delivery and Return Sub-System 108

In some embodiments, the automated kiosk management system 104 comprises a sports goods delivery and return sub-system 108 that manages automated delivery of sports goods 118 to the user and return of sports goods 118 from the user.

### Actuators 136

In some embodiments, the sports goods delivery and return sub-system 108 comprises one or more actuators 136. In some embodiments, the actuators 136 are one or more electric motors attached with gears and other mechanical linkages to enable actuation of various components and sub-assemblies of the kiosk assembly 100, such as the conveyance assembly 122, the actuable door 124, actuable lock 126, and the safety panel 128. In some embodiments, the actuators 136 can be actuators available off-the shelf or can be custom made using electric motors and suitable gears and other mechanical linkages, known to persons skilled in the art. In some embodiments, additional types of actuators, such as, hydraulic, pneumatic, piezoelectric, thermal, or other types of actuators can be used as per requirement.

### Second Communication Circuit 138

In some embodiments, the sports goods delivery and return sub-system comprises a second communication circuit 138 that communicates with the user interaction sub-system 106 or devices external to the kiosk assembly 102 via a wired or wireless mode of communication. In some embodiments, the second communication circuit 138 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks.

### Second Control Circuit 140

In some embodiments, the sports goods delivery and return sub-system comprises a second control circuit 140 configured to operate the one or more actuators 136 and the second communication circuit 138. In some embodiments, the second control circuit 140 may be a microcontroller available off-the-shelf in the market, such as, Programmable Logic Controller (PLCs), Distributed Control Systems (DCS), Programmable Automation Controller (PACs), and similarly available controllers in the market.

In some embodiments, the second communication circuit 138 is integrated with or communicatively linked to the second control circuit 140. In some embodiments, the second communication circuit 138 and the second control circuit 140 is integrated on a single circuit board and housed in a protective casing positioned suitably within the kiosk assembly 100. In some embodiments, the actuators 136 are connected to the second control circuit 140 via a wired connection.

### Hygiene Management Sub-System 110

In some embodiments, the automated kiosk management system 104 comprises a hygiene management sub-system 110 that manages cleaning and disinfection of the sports goods 118.

### UV Disinfecting Light 142

In some embodiments, the hygiene management sub-system 110 comprises at least one UV disinfecting light 142 positioned in the first storage compartment 116. In some embodiments, the UV disinfectant light 142 can be any off-the-shelf available UV disinfectant or sterilization lights known to persons skilled in the art. In some embodiments, as shown in FIGS. 1B-1C, the UV disinfectant light 142 is positioned on an internal wall of the first storage compartment. In some other embodiments, the UV disinfectant light 142 can be placed anywhere else on the kiosk assembly 100, for example, inside the loading dock 120, or on the actuable door 124, or on the safety panel 128. A person skilled in the art can also think of several other places where one or more UV disinfectant lights 142 can be placed to disinfect sports goods 118 within the kiosk assembly 100.

### Other Disinfectant or Sterilization Systems

In some embodiments, the hygiene management sub-system 110 comprises at least one of a chemical disinfectant spray assembly, heat disinfection assembly, laser cleaning system, a steam sterilization system, and a washing system. For example, some embodiments of the hygiene management sub-system 110 can also include a sterilizing laser within the loading dock 120 to sterilize the surface of sports goods 118 when they are placed in the loading dock 120. In some other embodiments, a chemical disinfectant spray system can be installed in the loading dock 120 or the first storage compartment 116 to disinfect the sports goods 118 periodically or upon delivery or receiving of the sports goods 118 in the kiosk assembly 100. In some embodiments, the hygiene management sub-system 110 comprises a steam sterilization system positioned in the loading dock 120 to sterilize the surface of sports goods 118 when they are placed in the loading dock 120. In some embodiments, the hygiene management sub-system 110 comprises a heat disinfection assembly positioned in the loading dock 120 to sterilize the surface of sports goods 118 when they are placed in the loading dock 120. In some embodiments, the hygiene management sub-system 110 comprises a washing system positioned in the loading dock 120 to wash the sports goods 118 when they are placed in the loading dock 120.

### Third Communication Circuit 144

In some embodiments, the hygiene management sub-system 110 comprises a third communication circuit 144 that communicates with the user interaction sub-system 106 or devices external to the kiosk assembly 102 via a wired or wireless mode of communication. In some embodiments, the third communication circuit 144 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks.

### Third Control Circuit 146

In some embodiments, the hygiene management sub-system 110 comprises a third control circuit 146 configured to operate the hygiene management sub-system 110. In some embodiments, the third control circuit 146 may be a microcontroller available off-the-shelf in the market, such as, Programmable Logic Controller (PLCs), Distributed Control Systems (DCS), Programmable Automation Controller (PACs), and similarly available controllers in the market.

In some embodiments, the third communication circuit 144 is integrated with or communicatively linked to the third control circuit 146. In some embodiments, the third communication circuit 144 and the third control circuit 146 is integrated on a single circuit board and housed in a protective casing positioned suitably within the kiosk assembly 100. In some embodiments, the UV disinfectant lights 142 is connected to the third control circuit 146 via a wired connection. In some embodiments, the chemical disinfectant spray assembly is connected to third control circuit 146 via a wired connection. In some embodiments, the steam sterilization system is connected to third control circuit 146 via a wired connection. In some embodiments, the heat disinfection assembly is connected to third control circuit 146 via a wired connection. In some embodiments, the laser cleaning system is connected to third control circuit 146 via a wired connection. In some embodiments, the washing system is connected to third control circuit 146 via a wired connection.

### Quality Management Sub-System 112

In some embodiments, the automated kiosk management system 104 comprises a quality management sub-system 112 that manages maintenance and recycling of the sports goods 118.

### Vision System 148

In some embodiments, the quality management sub-system 112 comprises a vision system 148 to identify sports goods 118 needing maintenance or recycling.

In some embodiments, the vision system 148 comprises one or more vision sensors, such as, but not limited to a camera, a LIDAR system, an ultraviolet imaging system, an infrared imaging system, a thermal imaging system, and an acoustic imaging system. In some embodiments, the vision sensors can be positioned in the loading dock 120 to visually inspect sports goods 118 being delivered to users or being returned by users.

In some embodiments, the vision system 148 comprises a neural network circuit trained to identify sports goods needing maintenance or recycling. In some embodiments, the vision system 148 can include an AI microcontroller, such as MAX78000 or MAX78002 from Analog Devices having trained on identifying images of cameras and data feeds of other vision sensors to determine potential flaws and damage to sports goods 118 being delivered to a user or being received from a user.

In some embodiments, the vision system 148 flags defective sports goods 118 and prevents said sports goods from being placed in the first storage compartment 116.

### Second Storage Compartments 150

In some embodiments, the quality management sub-system 112 comprises one or more second storage compartments 150 for storing sports goods 118 identified as needing maintenance or repair. In some embodiments, the second storage compartments 150 may be separate from the first storage compartment 116, and are configured to store sports goods 118 needing maintenance or repair. In some embodiments, each second storage compartment 150 includes an actuable door and an actuable lock, similar to the actuable door 124 and the actuable lock 126 of the loading dock 120a, and said actuable door and actuable lock of each second storage compartment 150 can be controlled by and be connected via wired connection to the second control circuit 140 of the sports goods delivery and return sub-system 108.

In some embodiments, when the vision system 148 flags defective sports goods 118, the second control circuit 140 can open the actuable door and actuable lock of an empty second storage compartment 150 for the user to deposit the defective sports good 118 in said second storage compartment 150.

### Fourth Communication Circuit 152

In some embodiments, the quality management sub-system 112 comprises a fourth communication circuit 152 that communicates with the user interaction sub-system 106 or devices external to the kiosk assembly via a wired or wireless mode of communication. In some embodiments, the fourth communication circuit 152 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks.

### Fourth Control Circuit 154

In some embodiments, the quality management sub-system 112 comprises a fourth control circuit 154 configured to operate the quality management sub-system 112.

In some embodiments, the fourth control circuit 154 may be a microcontroller available off-the-shelf in the market, such as, Programmable Logic Controller (PLCs), Distributed Control Systems (DCS), Programmable Automation Controller (PACs), and similarly available controllers in the market.

In some embodiments, the vision system 148 and the fourth communication circuit 152 are integrated with or communicatively linked to the fourth control circuit 154. In some embodiments, the vision system 148, the fourth communication circuit 152, and the fourth control circuit 154 are integrated on a single circuit board and housed in a protective casing positioned suitably within the kiosk assembly 100.

In some embodiments, the fourth control circuit 154 communicates to the server 184 directly or via the first control circuit 134 and the first communication circuit 132 the availability of a defective sports good 118 in the second storage compartment 150. In some embodiments, the server 184 alerts a local authorized technician to recover the defective sports good 118 from the second storage compartment 150 for repair or recycling.

### Security Sub-System 156

In some embodiments, automated kiosk management system 104 comprises a security sub-system 156.

### External Cameras 158

In some embodiments, as shown in FIGS. 1A-1C, the security sub-system 156 comprises one or more external cameras 158 positioned outside the kiosk structure 102 to monitor user interaction with the kiosk assembly 100. In some embodiments, as shown in FIGS. 1B-1C, the external cameras 158 can be positioned near the top of the kiosk assembly 100 to monitor the area in periphery of the kiosk assembly 100. In some embodiments, the external cameras 158 can be selected from any off-the-shelf available cameras known to persons skilled in the art.

### Internal Cameras 160

In some embodiments, as shown in FIGS. 1B-1C, the security sub-system 156 comprises one or more internal cameras 160 positioned inside the kiosk structure 102 to monitor sports goods 118 in the first storage compartment 116, the conveyance system 122, and the loading dock 120. In some embodiments, the internal cameras 160 can be selected from any off-the-shelf available cameras known to persons skilled in the art.

### Audio Alarm 166.

In some embodiments, the security sub-system 156 comprises one or more of an audio alarm 166. In some embodiments, as shown in FIG. 1A, the audio alarm 166 can be placed on an external wall of the kiosk structure 102. In some embodiments, the audio alarm 166 can be an alarm or speaker system configured to make a loud sound upon activation to alert the users of the kiosk assembly 100 and people in proximity of the kiosk assembly 100. In some embodiments, audio alarm 166 can be selected from any off-the-shelf available audio alarms known to persons skilled in the art.

### Flashing Light 168

In some embodiments, the security sub-system 156 comprises at least one flashing light 168. In some embodiments, as shown in FIG. 1A, the flashing light 168 can be placed on an external wall of the kiosk structure 102. In some embodiments, the flashing light 168 can be a light source configured to make bright light flashes to alert the users of the kiosk assembly 100 and people in proximity of the kiosk assembly 100. In some embodiments, flashing light 168 can be selected from any off-the-shelf available flashing light 168 known to persons skilled in the art.

### Fifth Communication Circuit 162

In some embodiments, the security sub-system 156 comprises a fifth communication circuit 162 that communicates with the user interaction sub-system 106 or devices external to the kiosk assembly 102 via a wired or wireless mode of communication. In some embodiments, the fifth communication circuit 162 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks.

### Fifth Control Circuit 164

In some embodiments, the security sub-system 156 comprises a fifth control circuit 164 configured to operate the security sub-system 156.

In some embodiments, the fifth control circuit 164 may be a microcontroller available off-the-shelf in the market, such as, Programmable Logic Controller (PLCs), Distributed Control Systems (DCS), Programmable Automation Controller (PACs), and similarly available controllers in the market.

In some embodiments, the fifth communication circuit 162 is integrated with or communicatively linked to the fifth control circuit 164. In some embodiments, the fifth communication circuit 162, and the fifth control circuit 164 are integrated on a single circuit board and housed in a protective casing positioned suitably within the kiosk assembly 100. In some embodiments, the external cameras 158, internal cameras 160, audio alarm 166, and flashing light 168 are connected to the fifth control circuit 164 via a wired connection.

In some embodiments, the feed of the external cameras 158 and internal cameras 160 is streamed to the server 184 via the internet 180 directly via the fifth communication circuit 162. In some other embodiments, the feed of the external cameras 158 and internal cameras 160 is transferred from the fifth communication circuit 162 to the first communication circuit 132, and streamed to the server 184 via the first communication circuit 132. In some embodiments, the server 184 includes a machine learning system to identify unusual activities, such as theft or vandalism attempts at the kiosk assembly 100. In some embodiments, the server 184 upon determination of theft or vandalism attempts at the kiosk assembly sends signals to the fifth control circuit 164 to activate the audio alarm 166, and flashing light 168 to scare away any miscreants. In some other embodiments, the server 184 also alerts a security authority, such as local police, regarding the theft or vandalism incident along with images captured by the external cameras 158 and internal cameras 160 as evidence. In some embodiments, the server 184 alerts a local authorized technician to mend the damage caused to the kiosk assembly 100 in theft or vandalism incident.

### Sports Goods Tracking Sub-System 170

In some embodiments, the automated kiosk management system 104 comprises a sports goods tracking sub-system 170.

### QR Code Scanner 172

In some embodiments, the sports goods tracking sub-system 170 comprises a QR Code scanner 172 that scans QR codes printed on the sports goods 118. In some embodiments, as shown in FIGS. 1A-1C, the sports goods tracking sub-system 170 includes two QR Code scanner 172a and 172b, where the QR Code Scanner 172a is positioned at an outside wall of the kiosk structure 102 to allow a user to scan QR code of products being returned. In some embodiments, the QR Code Scanner 172b is positioned on an inside wall of the first storage compartment 116 at a location where, when the conveyance assembly 122 is carrying a sports good 118 from the loading dock to the first storage compartment 116 or vice versa, a QR code placed on the sports good 118 can be read by the QR Code Scanner 172b. In some embodiments, QR Code Scanners 172a and 172b allow the kiosk management system 104 to track the specific sports goods 118 being delivered to or being received from the kiosk assembly 100.

### RFID Reader 174

In some other embodiments, the sports goods tracking sub-system 170 comprises an RFID reader 174 that reads RFID Tag signatures of RFID Tags embedded in sports goods. In some embodiments, as shown in FIGS. 1A-1C, the sports goods tracking sub-system 170 includes two RFID readers 174a and 174b, where the RFID reader 172a is positioned at an outside wall of the kiosk structure 102 to allow a user to scan an RFID Tag embedded in the products being returned. In some embodiments, the RFID reader 174b is positioned on an inside wall of the first storage compartment 116 at a location where, when the conveyance assembly 122 is carrying a sports good 118 from the loading dock to the first storage compartment 116 or vice versa, a RFID tag placed on the sports good 118 can be read by the RFID reader 174b. In some embodiments, RFID readers 174a and 174b allow the kiosk management system 104 to track the specific sports goods 118 being delivered to or being received from the kiosk assembly 100.

### Sixth Communication Circuit 176

In some embodiments, the sports goods tracking sub-system 170 comprises a sixth communication circuit 176 that communicates with the user interaction sub-system 106 or devices external to the kiosk assembly 102 via a wired or wireless mode of communication. In some embodiments, the sixth communication circuit 176 can be a wireless communication circuit capable of connecting with simultaneously connecting to different wired or wireless communication modalities, such as, Coaxial Cable, Data bus, USB cable, Optical fiber, BLE, WiFi, 4G or 5G wireless networks.

### Sixth Control Circuit 178

In some embodiments, the sports goods tracking sub-system 170 comprises a sixth control circuit 178 configured to operate the sports goods tracking sub-system 170.

In some embodiments, the sixth control circuit 178 may be a microcontroller available off-the-shelf in the market, such as, Programmable Logic Controller (PLCs), Distributed Control Systems (DCS), Programmable Automation Controller (PACs), and similarly available controllers in the market.

In some embodiments, the sixth communication circuit 176 is integrated with or communicatively linked to the sixth control circuit 178. In some embodiments, the sixth communication circuit 176, and the sixth control circuit 178 are integrated on a single circuit board and housed in a protective casing positioned suitably within the kiosk assembly 100. In some embodiments, the QR Code Scanners 172a and 172b and RFID readers 174a and 174b are connected to the sixth control circuit 178 via a wired connection. In some embodiments, the sixth control circuit 178 communicates with the server 184 directly or via sixth communication circuit 176, the first control circuit 134 and the first communication circuit 132, and via the internet 180. In some embodiments, the communication from the sixth control circuit may include tracking data of sports goods initially stored in the first storage compartment 116. In instances, of discrepancies in the data indicating absence or loss of a sports good, or an unknown sports good being submitted, the server 184 instructs the automated kiosk management system 104 to take a necessary corrective action, or alerts a local authorized technician to check and correct the discrepancy.

### Method of Operation/Functioning of the Kiosk Assembly 100

The following sections provides an exemplary use cases of the kiosk assembly 100 to explain its functioning.

### 1. Rent of Tennis Racket and Purchase of Tennis Ball by a User.

In some embodiments, a user can interact with the user interaction sub-system 106 via the GUI on the touch screen display 130a of kiosk assembly 100 to select a tennis racket 118a for renting and a tennis ball 118c for purchase. The user interaction sub-system 106 may direct the user to pay the required amount for the rent of tennis racket 118a depending upon the specified time for renting, for example, 60 mins. Additionally, user interaction sub-system 106 may direct the user to pay for the purchase of the ball 118c. The user may make a payment via a mobile application installed on the user mobile 182. Alternatively, the user may pay via a QR code presented on the touchscreen display 130 for payment.

In some embodiments, after receipt of the payment by the user, the user interaction sub-system 106 may direct the sports goods delivery and return sub-system 108 to transfer the required tennis racket 118a to the loading dock 120a and the tennis ball to the loading dock 120b.

While the Tennis Racket 118a is transferred to the loading dock 120a from the first storage compartment 116, the sports goods tracking sub-system 170 registers the QR code printed on the tennis racket 118a to record its movement out of the kiosk assembly 100.

Alternatively, while the Tennis Racket 118a is transferred to the loading dock 120a from the first storage compartment 116, the sports goods tracking sub-system 170 registers the RFID Tag embedded in the tennis racket 118a to record its movement out of the kiosk assembly 100.

2. Return of the Tennis Racket after Rental Period.

The user upon using the tennis racket 118a for the specified period of time, uses the user interaction sub-system 106 via the GUI on the touchscreen display 130a of the kiosk assembly 100 to indicate his intention to return the tennis racket 118a. The GUI directs the user to scan the QR code or RFID Tag of the tennis racket 118a on the QR Code Scanner 172a or RFID Tag Reader 174a of the sports goods tracking sub-system 170 present on the outer wall of the kiosk structure 102. Upon scanning, if the details of the scanned tennis racket 118a matches the tennis racket 118a rented to the user, the user interaction sub-system 106 directs the sports goods delivery and return sub-system 108 to open the actuable door 124 to accept the tennis racket 118a in the loading dock 120a.

Upon receipt of the tennis racket 118a in the loading dock 120a, the quality management sub-system 112 checks for any defects in the tennis racket 118a, if no defects are found, the conveyance assembly 122 transfers the tennis racket 118a to its respective storage area in the first storage compartment 116. In case a defect is found, the user is directed to store the tennis racket 118a in the secondary storage compartment 150 and a damage charge is levied from the user. The quality management sub-system 112 also informs a local technician via the internet 180 to pick-up the damaged tennis racket 118a for repair or recycling depending upon the extent of damage.

In the scenario, where the tennis racket 118a is not damaged, upon return of the tennis racket 118a to the first storage compartment 116, the hygiene management sub-system 110 turns the UV disinfecting light 142 on for a specified period of time to disinfect the returned tennis racket 118a.

### 3. Attempt of Theft of Vandalism

In a scenario, a miscreant tries to steal a sports good 118 from the kiosk assembly 100 or tries to vandalize the kiosk assembly 100, the external cameras 158 detect such activity and the security sub-system 156 activates the audible alarm 166 and the flashing lights 168 to scare the miscreant. Also, the security sub-system 156 via the server 184 informs the local authorities, such as the local police force to take action against the miscreants.

There can be several additional scenarios that can be thought of by a person skilled in the art to use the kiosk assembly 100 described hereinabove.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A kiosk assembly for allowing a user to demo, rent, or purchase sports goods, the kiosk assembly comprising:
a kiosk structure; and
an automated kiosk management system comprising:
a user interaction sub-system for managing interactions with a user;
a sports goods delivery and return sub-system that manages automated delivery of sports goods to the user and return of sports goods from the user,
a hygiene management sub-system that manages cleaning and disinfection of the sports goods, and
a quality management sub-system that manages maintenance and recycling of the sports goods.

2. The kiosk assembly of claim 1, wherein the user interaction sub-system comprises:
a touch screen display to allow a user to engage with the kiosk assembly;
a first communication circuit that communicates with other sub-systems of the kiosk assembly and devices external to the kiosk assembly via a wired or wireless mode of communication; and
a first control circuit configured to operate the touch screen display and the first communication circuit.

3. The kiosk assembly of claim 1, wherein the kiosk structure comprises:
a protective enclosure;
at least one first storage compartment to store at least one sports good;
a loading dock for delivery of a sports good to the user or for receiving a sports good from the user; and
a conveyance system that conveys a sports good from the first storage compartment to the loading dock or conveys a sports good from the loading dock to the first storage compartment.

4. The kiosk assembly of claim 3, wherein the kiosk structure comprises an actuable door that is actuatable between a closed position and an open position, wherein the actuable door allows access of the loading dock to the user in the open position, and wherein the actuable door restricts access of the loading dock to the user in the closed position.

5. The kiosk assembly of claim 4, wherein the kiosk structure comprises an actuable lock that locks or unlocks the actuable door.

6. The kiosk assembly of claim 5, wherein the kiosk structure comprises a safety panel actuatable between a closed position and an open position, wherein the safety panel in the closed position disallows movement of any matter between the loading dock and the conveyance system, and wherein safety panel in the open position allows passage of sports goods between the loading dock and the conveyance system.

7. The kiosk assembly of claim 6, wherein the sports goods delivery and return sub-system comprises one or more actuators configured to operate the conveyance system, the actuable door, the actuable lock, and the safety panel.

8. The kiosk assembly of claim 7, wherein the sports goods delivery and return sub-system comprises:
a second communication circuit that communicates with the user interaction sub-system or devices external to the kiosk assembly via a wired or wireless mode of communication; and
a second control circuit configured to operate the one or more actuators and the second communication circuit.

9. The kiosk assembly of claim 3, wherein the hygiene management sub-system comprises at least one UV disinfecting light positioned in the first storage compartment.

10. The kiosk assembly of claim 3, wherein the hygiene management sub-system comprises at least one of a chemical disinfectant spray assembly, heat disinfection assembly, laser cleaning system, a steam sterilization system, and a washing system.

11. The kiosk assembly of claim 3, wherein the hygiene management sub-system comprises:
a third communication circuit that communicates with the user interaction sub-system or devices external to the kiosk assembly via a wired or wireless mode of communication; and
a third control circuit configured to operate the hygiene management sub-system.

12. The kiosk assembly of claim 3, wherein the quality management sub-system comprises:
a vision system to identify sports goods needing maintenance or recycling; and
one or more second storage compartments for storing sports goods identified as needing maintenance or repair.

13. The kiosk assembly of claim 12, wherein the vision system comprises at least one of a camera, a LIDAR system, an ultraviolet imaging system, an infrared imaging system, a thermal imaging system, and an acoustic imaging system.

14. The kiosk assembly of claim 13, wherein the vision system comprises a neural network circuit trained to identify sports goods needing maintenance or recycling.

15. The kiosk assembly of claim 12, wherein the quality management sub-system comprises:
a fourth communication circuit that communicates with the user interaction sub-system or devices external to the kiosk assembly via a wired or wireless mode of communication; and
a fourth control circuit configured to operate the quality management sub-system.

16. The kiosk assembly of claim 3, wherein automated kiosk management system comprises a security sub-system.

17. The kiosk assembly of claim 16, wherein the security sub-system comprises:
one or more cameras positioned outside the kiosk structure to monitor user interaction with the kiosk assembly; and
one or more cameras positioned inside the kiosk structure to monitor sports goods in the first storage compartment, the conveyance system, and the loading dock.

18. The kiosk assembly of claim 16, wherein the security sub-system comprises:
a fifth communication circuit that communicates with the user interaction sub-system or devices external to the kiosk assembly via a wired or wireless mode of communication; and
a fifth control circuit configured to operate the security sub-system.

19. The kiosk assembly of claim 16, wherein the security sub-system comprises one or more of an alarm and at least one flashing light.

20. The kiosk assembly of claim 1, wherein the automated kiosk management system comprises a sports goods tracking sub-system.
